(19) United States
(12) Patent Application Publication
(10) Pub. No.: US 2015/0210067 A1
(43) Pub. Date: Jul. 30, 2015

(54) APPARATUS AND METHOD FOR CONTINUOUS LIQUID PRINTING

(71) Applicant: E I DU PONT DE NEMOURS AND COMPANY, Wilmington, DE (US)

(72) Inventors: NUGENT TRUONG, VENTURA, CA (US); MATTHEW STAINER, GOLETA, CA (US)

(73) Assignee: E I DU PONT DE NEMOURS AND COMPANY, Wilmington, DE (US)

(21) Appl. No.: 14/163,314

(22) Filed: Jan. 24, 2014

(51) Int. Cl. B41J 2/03

(52) U.S. Cl. CPC B41J 2/03

(57) ABSTRACT

A continuous liquid printing apparatus and method includes a nozzle assembly moving along a linear path in forward and reverse directions. A feed tube formed in a loop has one end terminating at the nozzle assembly, and the loop is maintained in a fixed orientation relative to the nozzle assembly during printing operation of the nozzle assembly. The nozzle assembly may be one of a multitude of nozzle assemblies located within a printhead.

### BACKGROUND OF THE INVENTION

1. Field of the Invention

This invention relates to a printing apparatus and method for depositing a liquid composition on a surface, such as the depositing of a liquid composition containing an organic semiconductor material on an backplane, and particularly to a feed tube formed in a loop and maintained in a fixed orientation relative to a nozzle assembly throughout the printing operation.

2. Description of the Related Art

An electronic device can include a liquid crystal display (“LCD”), an organic light-emitting diode (OLED) display, or the like. The manufacture of electronic devices may be performed using solution deposition techniques. One process of making electronic devices is to deposit organic layers over a substrate by printing (e.g., ink-jet printing, continuous printing, etc.). In a printing process, the liquid composition being printed includes an organic material in a solution, dispersion, emulsion, or suspension with an organic solvent, with an aqueous solvent, or with a combination of solvents. After printing, the solvent(s) is(are) evaporated and the organic material remains to form an organic layer for the electronic device.

Organic electronic devices utilizing organic active materials are used in many different kinds of electronic equipment. The term “organic electronic device” is intended to mean a device, such as an organic light emitting diode (OLED), that includes one or more layers of organic semiconductor materials laminated between other supporting layers and sandwiched by two electrodes.

Each organic material is carried in a liquid composition. During manufacture of a device each liquid composition is dispensed from a dedicated nozzle assembly. The nozzle assemblies are grouped in nozzle sets, with one nozzle in each set dispensing a particular color of ink. Each nozzle assembly dispenses liquid and deposits that liquid along a longitudinal lane that extends across a backplane of the device. The nozzle assemblies in each set continuously dispense a liquid composition into a respective lane. The nozzle assemblies can be located within a printhead, and the printhead travels in a linear path in a first or forward direction, in addition to a second or reverse direction, while printing the liquid composition on the backplane.

The individual nozzle assemblies for each particular color in each nozzle assembly set are supplied as a group from a common manifold itself supplied from a suitable liquid composition supply source, or supply reservoir. The supply reservoir for each particular color is usually implemented as a communal reservoir. The supply reservoir may either directly hold a supply of liquid for the nozzle assemblies, or may hold a secondary container, such as a sealed pouch containing the particular colored liquid composition.

A feed tube is the conduit for the liquid composition from the manifold to an inlet portion of the nozzle assembly. The feed tube forms at least one loop, also referred to as a coil, between the manifold and the inlet portion of the nozzle assembly.

Liquid printing can be conducted in either non-continuous or continuous operation as disclosed in the prior art. Any pressure pulses in a non-continuous system are isolated from the dispensing of the liquid composition. One example of non-continuous liquid printing would be ink-jet printing where discreet droplets of liquid are ejected from a nozzle. Localized impulse to produce the liquid droplet is distinct and segregated from the liquid supply source, manifold, and feed tube. The arrangement in a continuous printing method does not enjoy the isolation of pressure pulses of the ink-jet printer.

Within the continuous printers, one option to eliminate or mitigate pressure pulses acting on the liquid composition is to arrange a stationary printer and move the target substrate upon which the liquid composition is deposited. Another option is to locate the manifold in close proximity to the nozzle to minimize pressure pulses traveling along the feed tube. However, in some instances a longer feed tube is required and the longer the feed tube the larger the pressure drop between the manifold and inlet to the nozzle, hence, larger pressures are required at the manifold to drive the liquid to the nozzle inlet. In addition, with anything above a minimal length the feed tubes can flex as a result of relative motion between the manifold and nozzle, resulting in pressure variations in the feed line and resultant pressure variations at the nozzle. When multiple nozzles are located within a single printhead the feed tubes to each of the multiple nozzles may have different lengths or characteristics which results in pressure variations between the nozzles, resulting in differences in the deposition rates of liquid from each nozzle and non-uniform printing patterns.

The above options to mitigate pressure variations are believed disadvantageous for some printing options where the nozzle, or multitude of nozzles, moves in a linear direction while continuous printing in both a forward and reverse direction, also called a forward and a reverse printing pass. This continuous linear printing exposes the nozzle(s) to dramatic acceleration and deceleration during each printing pass, and places further limitations on the available options to mitigate or eliminate pressure pulses at the inlet of each nozzle.

In view of the foregoing it is believed advantageous to provide an apparatus and method for orientation of a feed tube relative to a nozzle and maintaining this orientation throughout the printing operation.

### SUMMARY OF THE INVENTION

The present invention is directed to a continuous liquid printing apparatus and method which includes a nozzle assembly moving along a linear path in forward and reverse directions. A feed tube formed in a loop has one end terminating at the nozzle assembly, and the loop is maintained in a fixed orientation relative to the nozzle assembly during printing operation.

In accordance with the present invention a printing apparatus comprises a nozzle assembly, a feed tube and a connector to maintain position of the feed tube relative to the nozzle assembly. The nozzle assembly having an inlet and an exit, with a cross section of the nozzle assembly perpendicular to fluid flow direction within the nozzle assembly. The cross section periphery having a first point and a second point, the first and second points being diametrically opposed with a line connecting the first and second points being parallel to linear travel of the nozzle assembly during print operation.

The feed tube is formed in at least a first loop, with distal end of the feed tube connected to the inlet of the nozzle assembly. The loop is defined on a plane having a vector normal to the plane, and the vector normal to the plane is parallel to the line connecting the first and second points.

In at least one embodiment the feed tube is formed in a second loop. The second loop can be located on the same plane as the first loop.

In at least one embodiment the second loop is located on a second plane parallel to the plane of the first loop.

In at least one embodiment the first loop of the feed tube is wrapped around an elongated form.

In at least one embodiment the elongated form has a non-circular cross section.

In at least one embodiment the elongated form has a circular cross section.

In at least one embodiment for multiple nozzle assemblies, the feed tube is divided into multiple distal ends, with each distal end connected to the inlet of the respective multiple nozzle assemblies.

In at least one embodiment for multiple nozzle assemblies having multiple feed tubes, each feed tube is formed in at least one loop and having the distal ends of the multiple feed tubes connected to the inlets of the respective multiple nozzle assemblies.

A printing process with a nozzle assembly having an inlet and an exit. A feed tube formed in at least a first loop where the distal end of the feed tube is connected to the inlet of the nozzle assembly. The first loop is oriented so surface of the first loop defines a plane having a vector normal to the plane. Flowing ink through the feed tube into the nozzle assembly and printing by moving the nozzle assembly along a linear path perpendicular to the flow of ink from the exit of the nozzle assembly. The normal vector and linear path remain parallel to one another during printing.

In at least one embodiment the spatial distance remains constant between the nozzle assembly and first loop, and a printing target substrate is at a fixed distance from the exit of the nozzle assembly.

In at least one embodiment of the deposition of a continuous stream of liquid upon the substrate, this deposition occurs in a forward direction along the linear printing path. The substrate is moved, or indexed, perpendicular to the linear printing path, and a second continuous stream of liquid is deposited upon the substrate. The deposition of the second continuous stream of liquid occurs in a backward direction along the linear printing path.

In at least one embodiment multiple nozzle assemblies are located in parallel orientation within a printhead. Feed tubes are wrapped around an elongated form; the cross section of the elongated form defines a first plane and a normal vector to the first plane. The wrapped feed tubes defining at least a second plane being parallel to the first plane. Each feed tube has a distal end connected to an inlet of one of the multiple nozzle assemblies. Flowing liquid ink through the feed tubes into the nozzle assemblies and printing onto a substrate, the printing accomplished by moving the printhead along a linear path generally perpendicular to the flow of ink from the nozzle assemblies, with the linear path being parallel to the normal vector during printing.

### BRIEF DESCRIPTION OF THE DRAWINGS

The invention will be more fully understood from the following detailed description, taken in connection with the accompanying drawings, which form a part of this application and in which:

FIG. 1 represents an embodiment of the present invention with a nozzle assembly, a feed tube formed in a loop and a connector.

FIG. 2 represents an embodiment of the present invention with the loop of feed tube in a planar arrangement.

FIG. 3 represents an embodiment of the present invention with an elongated form in contact with the loop of the feed tube.

FIG. 4A represents an embodiment of the present invention with a circular cross section of the elongated form.

FIG. 4B represents an embodiment of the present invention with a non-circular cross section of the elongated form.

FIG. 5 represents a feed tube with multiple distal ends, as an embodiment of the present invention.

FIG. 6 represents an embodiment of the present invention with multiple nozzle assemblies located within a printhead.

Skilled artisans appreciate that objects in the figures are illustrated for simplicity and clarity and have not necessarily been drawn to scale. For example, the dimensions of some of the objects in the figures may be exaggerated relative to other objects to help to improve understanding of embodiments.

### DETAILED DESCRIPTION OF THE INVENTION

Many aspects and embodiments have been described above and are merely exemplary and not limiting. After reading this specification, skilled artisans appreciate that other aspects and embodiments are possible without departing from the scope of the invention.

Other features and benefits of any one or more of the embodiments will be apparent from the following detailed description, and from the claims.

Definitions and Clarification of Terms

Before addressing details of embodiments described below, some terms are defined or clarified.

The term “connector” is used to place or establish in relationship at least two distinct elements where more than one structure can be used between the two distinct elements.

The term “electronic device” or sometimes “organic electronic device” is intended to mean a device including one or more organic semiconductor layers or materials.

The term “elongated form” is used to describe a two-dimensional shape which is stretched out to define a three-dimensional form.

The term “feed tube” is intended to mean a pipe, conduit, or casing structure to direct a liquid from a first location to a second location.

The term “indexing” is intended to move in a controlled manner, such as a step change, and held at a position until commanded to move once again.

The term “ink” is used to describe a liquid for printing, where the liquid can be a solution, dispersion, or suspension.

The term “loop” is used to describe a curving or doubling of a line so as to form a closed or partly open curve within itself.

The term “nozzle assembly” is intended to mean a nozzle structure having several elements.

The term “substrate” is used to describe a surface in which printing liquid is placed after leaving a nozzle assembly.

In this specification, unless explicitly stated otherwise or indicated to the contrary by the context of usage, where an embodiment of the subject matter hereof is stated or described as comprising, including, containing, having, being composed of or being constituted by or of certain features or elements, one or more features or elements in addition to those explicitly stated or described may be present in the embodiment. An alternative embodiment of the disclosed subject matter hereof is described as consisting essentially of certain features or elements, in which embodiment features or elements that would materially alter the principle of operation or the distinguishing characteristics of the embodiment are not present therein. A further alternative embodiment of the described subject matter hereof is described as consisting of certain features or elements, in which embodiment, or in insubstantial variations thereof, only the features or elements specifically stated or described are present.

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the present invention, suitable methods and materials are described below. In case of conflict, the present specification, including definitions, will control. In addition, the materials, methods, and examples are illustrative only and not intended to be limiting.

To the extent not described herein, many details regarding specific materials, processing acts, and circuits are conventional and may be found in textbooks and other sources within the organic light-emitting diode display, photodetector, photovoltaic cell, and semiconductive member arts.

Description of Printing Apparatus and Method

Throughout the following detailed description similar reference characters refers to similar elements in all figures of the drawings.

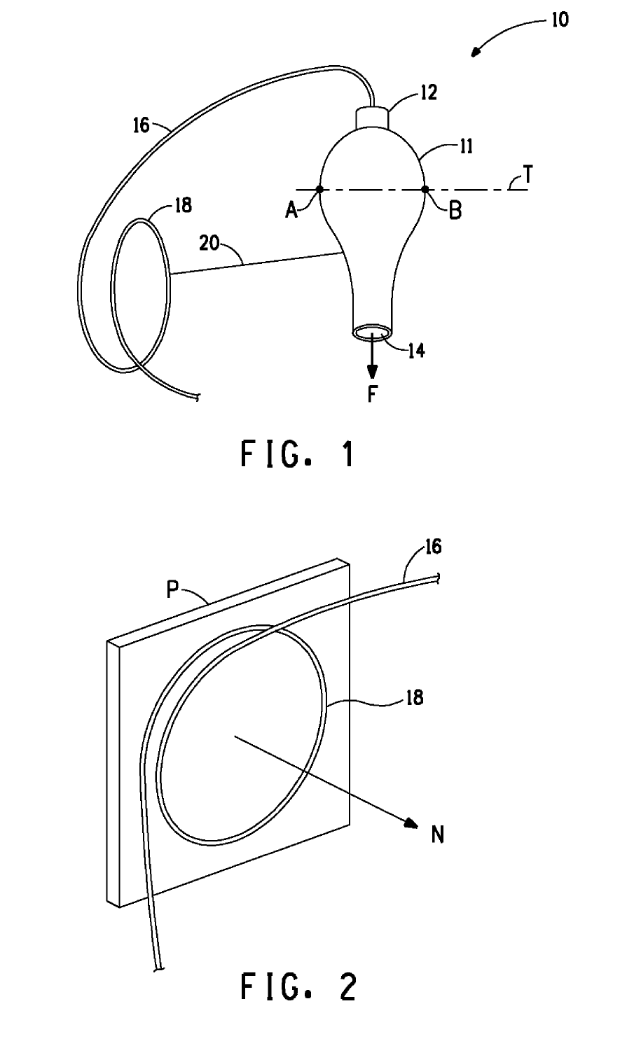

FIG. 1 represents an apparatus 10 containing a nozzle assembly 11 having an inlet 12 and an exit 14. A cross section of the nozzle assembly 11 is perpendicular to the flow F of liquid composition, or liquid ink, through the nozzle assembly 11. On the periphery of the cross section of nozzle assembly 11 are located a first point A and a second point B, points A and B are diametrically opposite on one another and lie on linear path T representing the printing path traversed by the nozzle assembly 11. A first direction, or forward direction, along linear path T can be described as the point A moving through the position previously occupied by point B. Likewise, a second direction, or backward direction, along linear path T can be described as the point B moving through the position previously occupied by point A. A feed tube 16 contains a loop 18 and a distal end connected to the inlet 12 of nozzle assembly 11. A connector 20 maintains position of the feed tube 16 and loop 18 relative to the nozzle assembly 11. The connector 20 can act through intervening structures (not shown) to maintain relative position between feed tube 16, loop 18 and nozzle assembly 11. Many types of mechanical fasteners can be used, including but not limited to metal or polymeric fasteners.

FIG. 2 represents the loop 18 of the feed tube 16 with the loop 18 defined as contacting a plane P having a vector N normal to the plane P. The vector N is parallel to the linear path T shown in FIG. 1. With this orientation the liquid within the loop 18 is not subject to longitudinal acceleration/deceleration during the printing operation which results in a surge of liquid, and associated pressure pulse, at the nozzle assembly 11. In addition, length of the feed tube 16 to include loop 18 expands the volume of liquid held between the manifold (not shown) and the nozzle assembly 11. This expanded volume is believed to function as capacitance to help further mitigate any pressure perturbations transmitted to the inlet 12 of the nozzle assembly 11.

FIG. 3 represents an elongated form 22 in contact with the loop 18 of the feed tube 16. The material constituting elongated form 22 can be of any type, in at least one embodiment the material can be polymer, with minimal weight being a desired characteristic of elongated form 22. Accordingly, the center portion of elongated form 22 can be hollow. In at least one embodiment the connector 20 can be attached (not shown) to the elongated form 22 to maintain relative position of the feed tube 16 and loop 18 relative to the nozzle assembly 11. Cross section of elongated form 22 is represented by 4-4′ which is perpendicular to centerline 25.

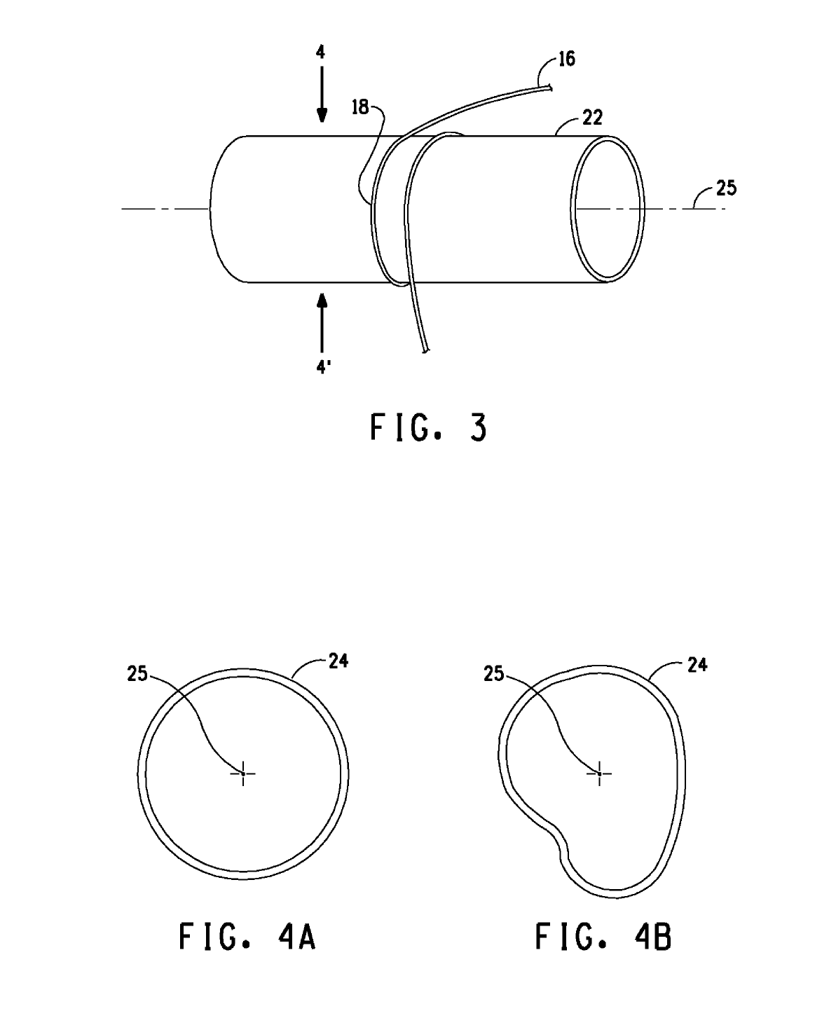

FIG. 4A represents a circular cross section 24 across 4-4′ of the elongated form 22. In at least one embodiment a constant radius is used in rotation from the centerline 25 to the interior surface of elongated form 22, as shown in circular cross section 24. The radius may also vary in a regular pattern to form an ellipse (not shown) or other shapes.

FIG. 4B represents a non-circular cross section 26 across 4-4′ of the elongated form 22. In at least one embodiment a variable radium is used in rotation from the centerline 25 to the interior surface of elongated form 22. In at least one embodiment an increased length of feed tube 16 is used in the loop 18 with the non-circular cross section 26.

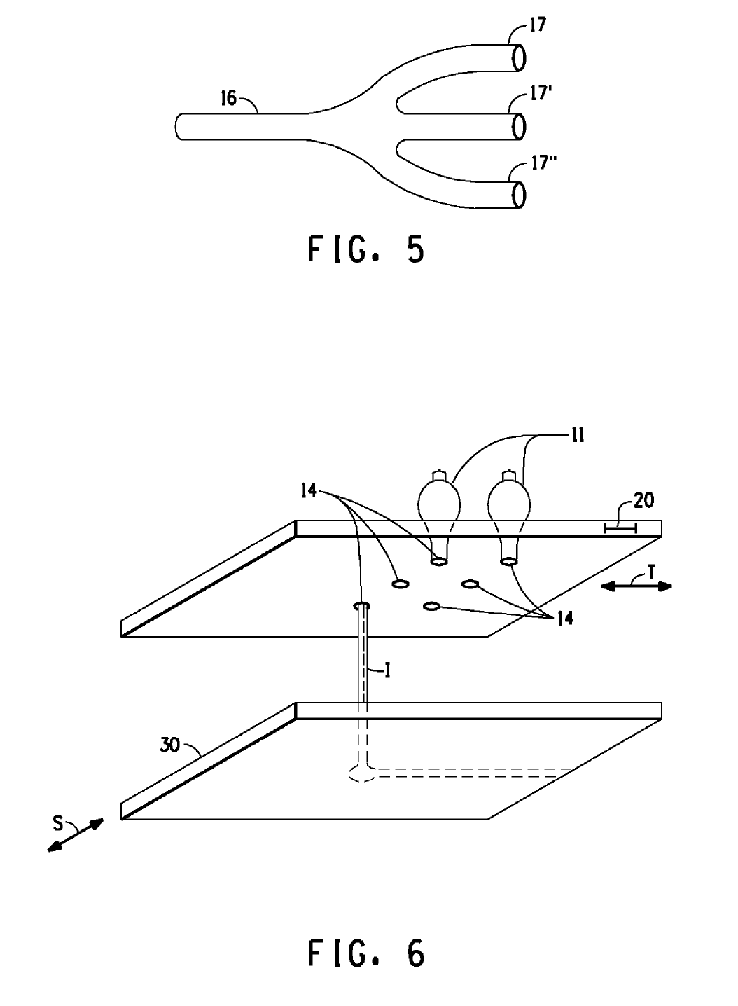

FIG. 5 represents the feed tube 16 having multiple distal ends 17, 17′, and 17″ to distribute liquid to multiple nozzle assemblies 11 (not shown) from a single feed tube 16.

FIG. 6 represents multiple nozzle assemblies 11 located within a printhead 28. Only two of the nozzle assemblies 11 are shown, but six of the exits 14 are shown. The nozzle assemblies 11 are generally parallel to one another and perpendicular to the plane of the printhead 28; the substrate 30 is generally parallel to the plane of the printhead 28 so exits 14 are at a fixed distance from the substrate 30. In at least one embodiment the connector 20 is attached to the printhead 28 and the elongated form 22 (not shown). The printhead 28 moves forward and backward along linear path T during print operations. In at least one embodiment printhead 28 moves in a forward direction along linear path T, at the end of this forward printing pass the substrate 30 is indexed along path S, followed by a backward printing pass of printhead 28. The liquid I is illustrated from one exit 14 flowing onto the substrate 30. Various combinations of printing and indexing can be used to produce any number of scenarios for continuous liquid printing.

Description of Electronic Device

Devices for which the printing method described herein can be used include organic electronic devices. The term “organic electronic device” or sometimes just “electronic device” is intended to mean a device including one or more organic semiconductor layers or materials. An organic electronic device includes, but is not limited to: (1) a device that converts electrical energy into radiation (e.g., a light-emitting diode, light emitting diode display, diode laser, or lighting panel), (2) a device that detects a signal using an electronic process (e.g., a photodetector, a photoconductive cell, a photoresistor, a photoswitch, a phototransistor, a phototube, an infrared (“IR”) detector, or a biosensors), (3) a device that converts radiation into electrical energy (e.g., a photovoltaic device or solar cell), (4) a device that includes one or more electronic components that include one or more organic semiconductor layers (e.g., a transistor or diode), or any combination of devices in items (1) through (4).

In such devices, an organic active layer is sandwiched between two electrical contact layers. At least one of the electrical contact layers is light-transmitting so that light can pass through the electrical contact layer. The organic active layer emits light through the light-transmitting electrical contact layer upon application of electricity across the electrical contact layers. Additional electroactive layers may be present between the light-emitting layer and the electrical contact layer(s).

It is well known to use organic electroluminescent compounds as the active component in such devices to provide the necessary colors. The printing method described herein is suitable for the printing of liquid compositions containing electroluminescent materials having different colors. Such materials include, but are not limited to, small molecule organic fluorescent compounds, fluorescent and phosphorescent metal complexes, conjugated polymers, and mixtures thereof. Examples of fluorescent compounds include, but are not limited to, chrysenes, pyrenes, perylenes, rubrenes, coumarins, anthracenes, thiadiazoles, derivatives thereof, and mixtures thereof. Examples of metal complexes include, but are not limited to, metal chelated oxinoid compounds, such as tris(8-hydroxyquinolato)aluminum (Alq3); cyclometalated iridium and platinum electroluminescent compounds, such as complexes of iridium with phenylpyridine, phenylquinoline, or phenylpyrimidine ligands as disclosed in Petrov et al., U.S. Pat. No. 6,670,645 and Published PCT Applications WO 03/063555 and WO 2004/016710, and organometallic complexes described in, for example, Published PCT Applications WO 03/008424, WO 03/091688, and WO 03/040257, and mixtures thereof. In some cases the small molecule fluorescent or organometallic materials are deposited as a dopant with a host material to improve processing and/or electronic properties. Examples of conjugated polymers include, but are not limited to poly(phenylenevinylenes), polyfluorenes, poly(spirobifluorenes), polythiophenes, poly(p-phenylenes), copolymers thereof, and mixtures thereof.

To form the printing inks, the above materials are dissolved or dispersed in a suitable liquid composition. A suitable solvent for a particular compound or related class of compounds can be readily determined by one skilled in the art. For some applications, it is desirable that the compounds be dissolved in non-aqueous solvents. Such non-aqueous solvents can be relatively polar, such as C₁ to C₂₀ alcohols, ethers, and acid esters, or can be relatively non-polar such as C₁ to C₁₂ alkanes or aromatics such as toluene, xylenes, trifluorotoluene and the like. Other suitable liquids for use in making the liquid composition, either as a solution or dispersion as described herein, comprising the new compounds, includes, but not limited to, chlorinated hydrocarbons (such as methylene chloride, chloroform, chlorobenzene), aromatic hydrocarbons (such as substituted and non-substituted toluenes and xylenes), including triflurotoluene), polar solvents (such as tetrahydrofuran (THP), N-methyl pyrrolidone) esters (such as ethylacetate) alcohols (isopropanol), keytones (cyclopentatone) and mixtures thereof. Suitable solvents for photoactive materials have been described in, for example, published PCT application WO 2007/145979.

One example of an organic electronic device structure is an OLED. The device has a first electrical contact layer, which is an anode layer, and a second electrical contact layer, which is a cathode layer. A photoactive layer is between them. Additional layers may optionally be present. Adjacent to the anode may be a buffer layer. Adjacent to the buffer layer may be a hole transport layer, comprising hole transport material. Adjacent to the cathode may be an electron transport layer, comprising an electron transport material. As an option, devices may use one or more additional hole injection or hole transport layers next to the anode and/or one or more additional electron injection or electron transport layers next to the cathode.

It should be appreciated from the foregoing description that the present invention serves to orient a feed tube with a nozzle assembly during printing along a linear printing path. This orientation in conjunction with restricting relative motion between the loop of the feed tube and the nozzle assembly serves to mitigate pressure pulses acting upon liquid flowing through the feed tube and nozzle assembly onto a substrate. Non-uniform deposition of the liquid on the substrate causes performance irregularities in the dried liquid, and by extension in an electronic device produced from the printed and subsequently dried liquid.

Those skilled in the art, having the benefit of the teachings of the present invention, may impart modifications thereto. Such modifications are to be construed as lying within the scope of the present invention, as defined by the appended claims.

What is claimed is:

1. A printing apparatus comprising:
a nozzle assembly having an inlet and an exit, cross section of the nozzle assembly is perpendicular to fluid flow direction within the nozzle assembly, the cross section periphery having a first point and a second point, the first and second points being diametrically opposed with a line connecting the first and second points being parallel to linear travel of the nozzle assembly during print operation;
a feed tube formed in at least a first loop, distal end of the feed tube is connected to the inlet of the nozzle assembly, wherein the loop is defined on a plane having a vector normal to the plane, wherein the vector normal to the plane is parallel to the line connecting the first and second points; and
a connector to maintain position of the feed tube relative to the nozzle assembly.

2. The printing apparatus of claim 1 wherein the feed tube is formed in a second loop.

3. The printing apparatus of claim 2 wherein the second loop is located on the same plane as the first loop.

4. The printing apparatus of claim 2 wherein the second loop is located on a second plane parallel to the plane of the first loop.

5. The printing apparatus of claim 1, further comprising:
an elongated form having an outer surface in contact with the first loop of the feed tube.

6. The printing apparatus of claim 5, wherein the elongated form has a circular cross section.

7. The printing apparatus of claim 5, wherein the elongated form has a non-circular cross section.

8. The printing apparatus of claim 1 further comprising:
multiple nozzle assemblies wherein the feed tube is divided into multiple distal ends, each distal end is connected to the inlet of the respective multiple nozzle assemblies.

9. The printing apparatus of claim 1 further comprising:
multiple nozzle assemblies;
multiple feed tubes, each feed tube formed in at least one loop,
wherein the distal ends of the multiple feed tubes are connected to the inlets of the respective multiple nozzle assemblies.

10. A printing process comprising:
providing a nozzle assembly having an inlet and an exit;
providing a feed tube formed in at least a first loop;
attaching distal end of the feed tube to the inlet of the nozzle assembly;
orienting the first loop so surface of the first loop defines a plane having a vector normal to the plane;
flowing ink through the feed tube into the nozzle assembly; and
printing by moving the nozzle assembly along a linear path perpendicular to the flow of ink from the exit of the nozzle assembly, wherein the normal vector and linear path remain parallel to one another during printing.

11. The printing process of claim 10 wherein a spatial distance remains constant between the nozzle assembly and first loop.

12. The printing process of claim 11 further comprising:
providing a substrate at a fixed distance from the exit of the nozzle assembly.

13. The printing process of claim 12 further comprising:
depositing a continuous stream of ink upon the substrate, wherein the stream of ink is forward along the linear path.

14. The printing process of claim 13 further comprising:
indexing the substrate perpendicular to the linear path;
depositing a second continuous stream of ink upon the substrate, wherein the stream is backward along the linear path.

15. The printing process of claim 11 further comprising:
providing an elongated form having an outer surface in contact with the first loop of the feed tube.

16. The printing process of claim 15 wherein the elongated form is non-circular in cross section.

17. The printing process of claim 10 further comprising:
multiple nozzle assemblies located within a printhead, wherein the feed tube is divided into multiple distal ends, each distal end is connected to the inlet of the respective multiple nozzle assemblies.

18. The printing process of claim 10 further comprising:
multiple nozzle assemblies located within a printhead;
multiple feed tubes, each feed tube formed in at least one first loop, wherein the distal ends of the multiple feed tubes are connected to the inlets of the respective multiple nozzle assemblies.

19. A printing process comprising:
providing multiple nozzle assemblies each having an inlet and an exit, the nozzle assemblies located in parallel orientation within a printhead;
providing multiple feed tubes, each feed tube formed in at least a first loop;
providing an elongated form;
orienting the elongated form so cross section of the elongated form defines a plane having a vector normal to the plane, all first loops formed around the elongated form, the elongated form is attached to the printhead;
attaching distal ends of the feed tubes to the inlets of the nozzle assemblies;
providing a substrate having surface exposed to exits of the nozzle assemblies;
flowing liquid ink through the feed tubes into the nozzle assemblies; and
printing by moving the printhead along a linear path perpendicular to the flow of ink from the exits of the nozzle assemblies, wherein the normal vector and linear path remain parallel to one another during printing.
